(19) United States
(12) Patent Application Publication
(10) Pub. No.: US 2019/0095963 A1
(43) Pub. Date: Mar. 28, 2019

(54) ELECTRONIC PLATFORM FOR SELLING AND BUYING USED VEHICLES

(71) Applicant: PIPESET INC., Russell (CA)

(72) Inventor: Raymond MARTIN, Russell (CA)

(73) Assignee: PIPESET INC., Russell (CA)

(21) Appl. No.: 16/142,521

(22) Filed: Sep. 26, 2018

Related U.S. Application Data
(60) Provisional application No. 62/563,385, filed on Sep. 26, 2017.

(51) Int. Cl. G06Q 30/02; G06Q 10/00; B60W 40/09

(52) U.S. Cl. CPC G06Q 30/0278; B60W 40/09; G06Q 10/20

(57) ABSTRACT

An electronic system for determining a state of at least one vehicle for sale, the system comprising: an electronic unique identifier associated with said at least one vehicle; an electronic sensing device associated with said at least one vehicle; said electronic sensing device comprising: at least one sensing element for acquiring in real-time information pertaining to a state of said at least one vehicle and acquiring in real-time information pertaining to the driving habits of an operator of said at least one vehicle; processing said acquired information to generate data pertaining to said at least one vehicle; a processing unit, a memory, one or more programs stored in said memory and configured to be executed by said processing unit; coupled to said network via a transceiver, said processing unit receiving at least one vehicle history report associated with said at least one vehicle; at least one maintenance report associated with said at least one vehicle; generating a master report based on said at least one vehicle history report, said at least one maintenance report and acquired information, said master report pertaining to a state of said at least one vehicle; and determining a fair market value of said at least one vehicle based on said master report; and a display interface coupled to said processing unit for presentation of said reports, said acquired information and said fair market value.

### CROSS-REFERENCE TO RELATED APPLICATIONS

This application claims priority to U.S. Provisional Application Ser. No. 62/563,385 filed on Sep. 26, 2017.

### FIELD OF INVENTION

The present invention relates to an electronic platform for buying and selling used vehicles.

### BACKGROUND

For most people buying a pre-owned vehicle is a stressful experience, as they are usually unsure of the true condition of the vehicle, and are forced to take the seller's word for it. In the buyer's mind there is almost always a nagging feeling that they may be buying a lemon, or that they are not obtaining the best value for their money. Although it is strongly recommended to have an independent vehicle inspection by a mechanic, most buyers simply are unable to coordinate such an inspection, usually due to sales pressure tactics, limited time, or unwillingness on the owner's part to relinquish the vehicle for scrutiny. Furthermore, buying a vehicle online or at an auction does not make it conducive to arrange for independent inspections prior to bidding for the vehicle, as they are usually multiple bidders, individuals or dealers, that are willing to make purchases without independent inspections.

On the seller's side, there also exists the challenge to convince a buyer of the true condition of the vehicle, and justify the selling price for the vehicle, since the seller too lacks true knowledge of the true condition of the vehicle.

To address the buyers and sellers' concerns, vehicle maintenance records and a vehicle history report are often used to assess the condition of the vehicle. However, most vehicle history reports are not complete, and may not include the true mileage or indicate whether the vehicle has been salvaged, rebuilt, recovered from a theft, or sustained water damage. Furthermore, not all insurance companies disclose or share their accident information to companies that compile these vehicle history reports, and even if the accident is reported, the extent of the accident damages, or the quality of any repairs, are not included in the vehicle history report. Another disconcerting fact about vehicle history report is that none of the information contained therein is ever verified by the companies that compile these vehicle history reports, and therefore it is not uncommon to find discrepancies in these reports.

With respect to the selling price of a vehicle, most buyers and sellers rely on vehicle appraisal websites, such as the ones operated by Kelly Blue Book®, NADA®, and Edmunds®, for vehicle valuation and appraisal information. Unfortunately, these appraisal web sites merely provide ballpark estimates, and at times are misleading, as they do not consider the true, current condition of the vehicle.

Inordinate amounts of resources, time and money, are typically spent in assembling voluminous information from these disparate sources in an attempt to determine the true condition of a pre-owned vehicle and its fair price, before making an informed decision to purchase or sell.

It is an object of the present invention to mitigate or obviate at least one of the above-mentioned disadvantages.

### SUMMARY OF THE INVENTION

In one of its aspects, there is provided an electronic system for determining a state of at least one vehicle for sale, the system comprising:
an electronic unique identifier associated with said at least one vehicle;
an electronic sensing device associated with said at least one vehicle; said electronic sensing device comprising:
   at least one sensing element for acquiring in real-time information
   pertaining to a state of said at least one vehicle and acquiring in real-time information pertaining to the driving habits of an operator of said at least one vehicle; processing said acquired information to generate data pertaining to said at least one vehicle;
a processing unit, a memory, one or more programs stored in said memory and configured to be executed by said processing unit; coupled to said network via a transceiver, said processing unit receiving at least one vehicle history report associated with said at least one vehicle; at least one maintenance report associated with said at least one vehicle; generating a master report based on said at least one vehicle history report, said at least one maintenance report and acquired information, said master report pertaining to a state of said at least one vehicle; and determining a fair market value of said at least one vehicle based on said master report; and a display interface coupled to said processing unit for presentation of said reports, said acquired information and said fair market value.

In another of its aspects, there is provided a computer-implemented method for determining a state of at least one vehicle, the method comprising the steps of:
associating said at least one vehicle with an electronic unique identifier;
associating said at least one vehicle with an electronic sensing device;
at said electronic sensing device, acquiring information pertaining to a state of said at least one vehicle and acquiring information pertaining to the driving habits of an operator of said at least one vehicle;
at a processing unit comprising a memory, one or more programs stored in said memory and configured to be executed by said processing unit, receiving said acquired information and determining said state of said at least one vehicle and acquiring said driving habits of said operator of said at least one vehicle;
at the processing unit, receiving at least one vehicle history report and at least one maintenance report associated with said at least one vehicle; and generating a master report pertaining to a state of said at least one vehicle based on said at least one vehicle history report, said at least one maintenance report, and said acquired data; at the processing unit, receiving at least one vehicle history report and at least one maintenance report associated with said at least one vehicle; and generating a master report pertaining to a state of said at least one vehicle, said master report based on at least one of said at least one vehicle history report, said at least one maintenance report, and said acquired data; and determining a fair market value of said at least one vehicle based on said reports and said acquired data; and on a display interface coupled to said processing unit, presenting said reports, said acquired information and said fair market value.

In another of its aspects, there is provided a computer-implemented method for buying and selling at least one vehicle, the method comprising the steps of:
associating said at least one vehicle with an electronic unique identifier;
associating said at least one vehicle with an electronic sensing device;
at said electronic sensing device, acquiring information pertaining to a state of said at least one vehicle and acquiring information pertaining to the driving habits of an operator of said at least one vehicle;
at a processing unit comprising a memory, one or more programs stored in said memory and configured to be executed by said processing unit, receiving said acquired information and determining said state of said at least one vehicle and acquiring said driving habits of said operator of said at least one vehicle;
at the processing unit, receiving at least one vehicle history report and at least one maintenance report associated with said at least one vehicle; and generating a master report pertaining to a state of said at least one vehicle based on said at least one vehicle history report, said at least one maintenance report, and said acquired data, and
presenting said master report on a display interface.

In another of its aspects, there is provided a computer-implemented method for determining a state of at least one pre-owned vehicle buying and selling a pre-owned vehicle, the method comprising steps of:
associating the vehicle with a unique identifier;
monitoring usage of at least one component of the vehicle via networked-connected devices in real-time;
acquiring data from the networked-connected devices; receiving an independent inspection report comprising images and video of the vehicle and the at least one component of the vehicle;
from a third-party database, receiving at least one of a vehicle history report, review, maintenance records, vehicle valuation and appraisal information associated with the uniquely-identified vehicle; generating a comprehensive vehicle report comprising the acquired real-time data, the inspection report, and data from the third-party databases; and rating the condition of said vehicle and valuating said vehicle based on said comprehensive vehicle report.

Advantageously, the platform allows consumers to buy or sell their vehicles in a safe, transparent and anonymous manner. The platform generates a comprehensive report about the vehicle based on inspection reports from an independent inspection conducted by a certified mechanic and real-time data received from tamper-proof electronic control units (ECUs) associated with the vehicle, and tamper-proof networked sensor devices e.g. Internet-of-Things (IoT) devices. The deficiency reports include real-time data about how the vehicle is driven and maintained, and a listing of mechanical problems, error codes, component or system failures, and how these deficiencies were addressed, when they were addressed, and if or when they were resolved, including identification of the responsible parties. The platform therefore collects and records valuable information on the driver's behavior and other data in real-time and helps determine the condition and fair market value of the vehicle at the time of resale. Having the vehicle history information recorded by tamper-proof devices provides a great advantage over subjective or biased inspections or missing data, and minimizes fraudulent activities, such as non-reporting of accidents or damage and repairs, including non-reporting of faults or unknown faults. Furthermore, the data from the ECUs and IoT devices, combined with the maintenance schedule allows the platform to issue to alerts when, or before, maintenance is due. In addition, the platform collects information from the buyer and the seller, and keeps it private such that neither the buyer nor the seller has access to each other's information, except for the vehicle information, and therefore the platform operator becomes a neutral 3^{rd} party in the transaction. Therefore, the transaction is anonymous in nature, as the buyer's and seller's information is not shared until after the sale of the vehicle, when transaction actually takes place.

### BRIEF DESCRIPTION OF THE DRAWINGS

Several exemplary embodiments of the present invention will now be described, by way of example only, with reference to the appended drawings in which:

FIG. 1 shows an exemplary computing system;

FIG. 2 shows an exemplary environment in which a method and system for anonymously buying and selling vehicles operate;

FIG. 3 shows a high-level flow diagram illustrating an exemplary process steps for registering a user to sell a vehicle;

FIG. 4a shows an exemplary user interface for registration;

FIG. 4b shows an exemplary user interface for mobile verification;

FIG. 4c shows an exemplary user interface corresponding to a self-financing option;

FIG. 4d shows an exemplary user interface for paying a deposit;

FIG. 4e shows an exemplary user interface for applying for financing;

FIG. 4f shows an exemplary user interface for entering co-borrower information;

FIG. 4g shows an exemplary user interface for the mobile verification process;

FIG. 5 shows an exemplary user interface for selling a vehicle or starting an auction and obtaining a price estimate for the vehicle;

FIG. 6 shows an exemplary flowchart of an overview of a method for registering a vehicle and making it available for sale;

FIG. 7 shows an exemplary user interface for entering details about the vehicle, including wear and tear;

FIG. 8 shows an exemplary flowchart of an overview of a bidding process; and

FIG. 9 shows an exemplary flowchart of an overview of an outbound process following the closing of an auction.

### DETAILED DESCRIPTION OF EXEMPLARY EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

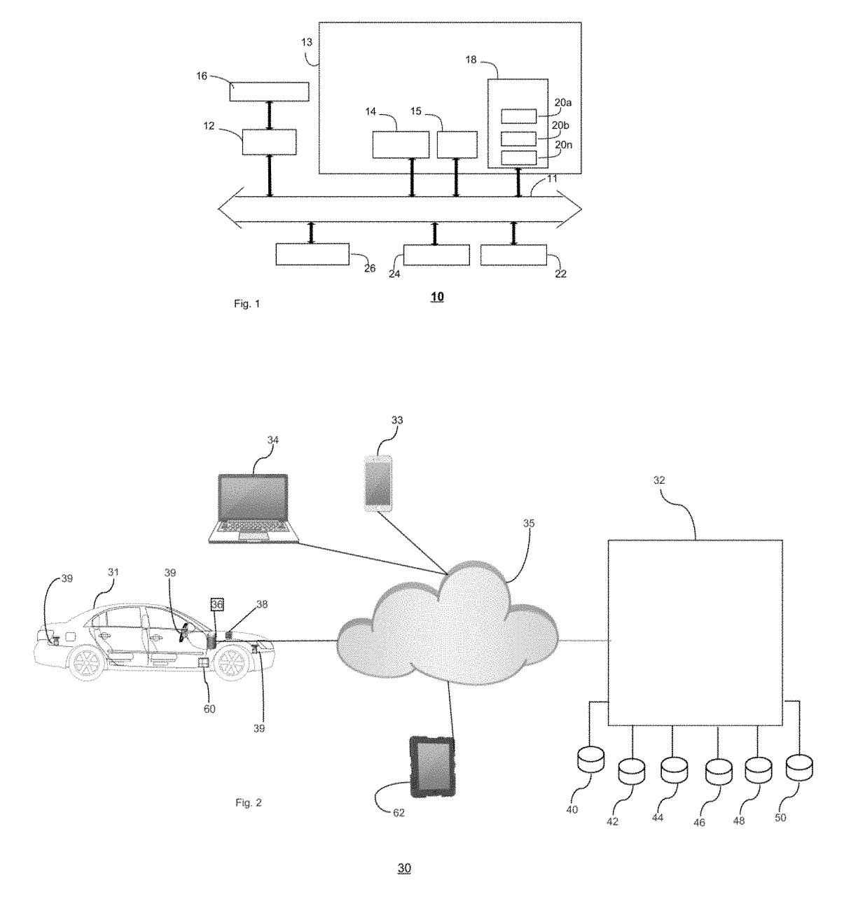

A detailed discussion of the methods and systems surrounding the concepts of buying and selling pre-owned vehicles is provided below. First, a brief introductory description of a basic general-purpose system or computing device which can be employed to practice the concepts is illustrated in FIG. 1.

With reference to FIG. 1, an exemplary computing system or general-purpose computing device 10 comprises processing unit (CPU or processor) 12 and system bus 11 that couples various system components including system memory 13 such as read only memory (ROM) 14 and random access memory (RAM) 15 to processor 12. System 10 can include a cache 16 of high speed memory connected directly with, in close proximity to, or integrated as part of processor 12. System 10 copies data from memory 13 and/or storage device 18 to cache 16 for quick access by processor 12. In this way, the cache provides a performance boost that avoids processor 12 delays while waiting for data. These and other modules can control or be configured to control processor 12 to perform various actions. Other system memory 13 may be available for use as well. Memory 13 can include multiple different types of memory with different performance characteristics. It can be appreciated that the methods and system may operate on computing device 10 with more than one processor 12 or on a group or cluster of computing devices networked together to provide greater processing capability. Processor 12 can include any general-purpose processor and a hardware module or software module, such as module 1 20a, module 2 20b, and module 3 20c stored in storage device 18, configured to control processor 12 as well as a special-purpose processor where software instructions are incorporated into the actual processor design. Processor 12 may essentially be a completely self-contained computing system, containing multiple cores or processors, a bus, memory controller, cache, etc. A multi-core processor may be symmetric or asymmetric.

System bus 11 may be any of several types of bus structures including a memory bus or memory controller, a peripheral bus, and a local bus using any of a variety of bus architectures. A basic input/output (BIOS) stored in ROM 14 or the like, may provide the basic routine that helps to transfer information between elements within computing device 10, such as during start-up. Computing device 10 further includes storage devices 18 such as a hard disk drive, a magnetic disk drive, an optical disk drive, a solid-state drive, a tape drive or the like. Storage device 18 can include software modules 20a, 20b, 20n for controlling processor 12. Other hardware or software modules are contemplated. Storage device 18 is connected to system bus 11 by a drive interface. The drives and the associated computer readable storage media provide non-volatile storage of computer readable instructions, data structures, program modules and other data for computing device 10. In one aspect, a hardware module that performs a particular function includes the software component stored in a non-transitory computer-readable medium in connection with the necessary hardware components, such as processor 12, bus 11, display 22, and so forth, to carry out the function. The basic components are known to those of skill in the art and appropriate variations are contemplated depending on the type of device, such as whether device 10 is a handheld computing device, a desktop computer, or a computer server.

Although the exemplary embodiment described herein employs the hard disk 18, it should be appreciated by those skilled in the art that other types of computer readable media which can store data that are accessible by a computer, such as magnetic cassettes, flash memory cards, digital versatile disks, cartridges, random access memories (RAMs) 15, read only memory (ROM) 14, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 10, input device 24 represents any number of input mechanisms, such as a microphone for speech, a touch-sensitive screen for gesture or graphical input, keyboard, mouse, motion input, speech and so forth. Output device 22 can also be one or more of a number of output mechanisms known to those of skill in the art. In some instances, multimodal systems enable a user to provide multiple types of input to communicate with computing device 10. Communications interface 26 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks, including functional blocks labeled as a “processor” or processor 12. The functions these blocks represent may be provided through the use of either shared or dedicated hardware, including, but not limited to, hardware capable of executing software and hardware, such as processor 12, that is purpose-built to operate as an equivalent to software executing on a general-purpose processor. For example, the functions of one or more processors, presented in FIG. 1, may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 14 for storing software performing the operations discussed below, and random access memory (RAM) 15 for storing results. Very large-scale integration (VLSI) hardware embodiments, as well as custom VLSI circuitry in combination with a general-purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 10, shown in FIG. 1, can practice all or part of the recited methods, can be a part of the recited systems, and/or can operate according to instructions in the recited non-transitory computer-readable storage media. Such logical operations can be implemented as modules configured to control processor 12 to perform particular functions according to the programming of the module. For example, FIG. 1 illustrates three modules 20a, 20b and 20n which are modules configured to control processor 12. These modules 20a, 20b and 20n may be stored on storage device 18 and loaded into RAM 15 or memory 13 at runtime or may be stored, as would be known in the art, in other computer-readable memory locations.

Computer system 10 can be of varying types including a workstation, server, computing cluster, blade server, server farm, or any other data processing system or computing device. Due to the ever-changing nature of computers and networks, the description of computer system 10 depicted in FIG. 1 is intended only as a specific example for purposes of illustrating some implementations. Many other configurations of computer system 10 are possible having more or fewer components than the computer system depicted in FIG. 1.

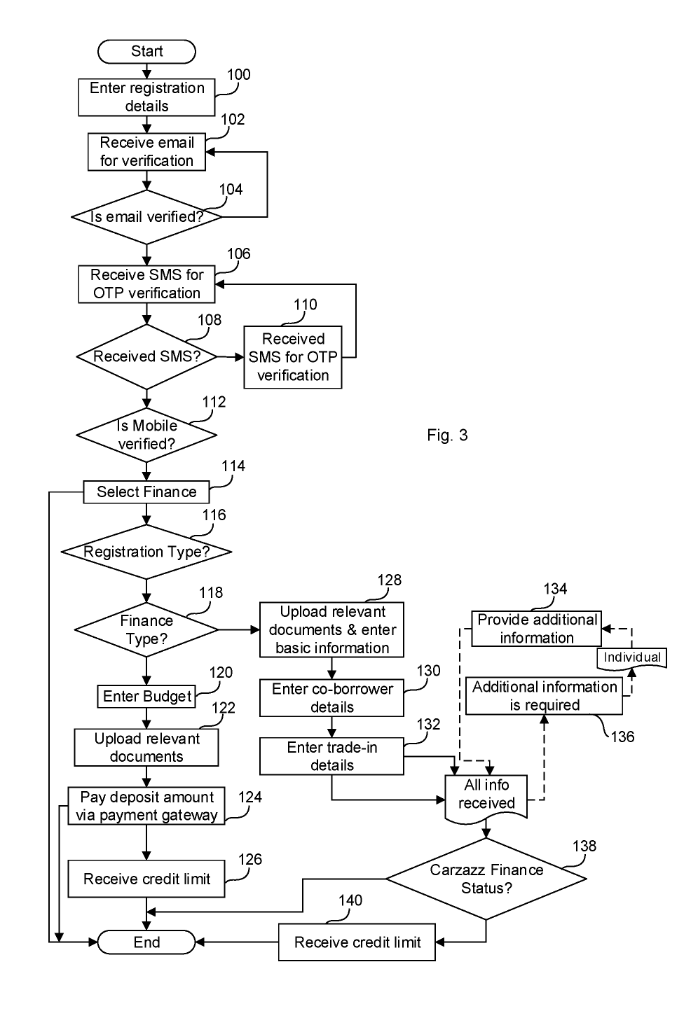

A detailed description of the methods and systems surrounding the concepts of generating split questionnaires will now follow. Several variations shall be discussed herein as the various embodiments are set forth. FIG. 2 shows a top-level component architecture diagram of an exemplary environment, generally identified by reference numeral 30, for which the methods and systems for buying and selling vehicles 31 operate. As shown, FIG. 2 illustrates environment 30, in which a user interacts with server computer 32, such as an application server, through user mobile device 33 or user computer 34 communicatively coupled thereto via communication medium 35, or network, e.g., the Internet, and/or any other suitable network. The computers of environment 30 comprise the features of the general-purpose computing device 10, as described above, and may include, but are not limited to: a mini computer, a handheld communication device, e.g. a tablet, a mobile device, a smart phone, a smartwatch, a wearable device, a personal computer, a server computer, a series of server computers, and a mainframe computer. Vehicle 31 includes a vehicle data acquisition system 36 comprising a plurality of electronic control units (ECUs) 38 via an I/O port, such as an OBD2 (On-Board Diagnosis) interface, communicatively coupled to. Vehicle data acquisition system (DAS) 36 receives data from the various electronic systems associated with vehicle 31, including, but not limited to, the engine, braking systems, air bag system, and sends information about service requirements, critical alerts, engine health, driving data, fuel economy, engine temperature, service alerts and engine load, among others. This data is requested and received without any user intervention, and is then transmitted to server computer 32, where it is parsed and analyzed for implementation in driver behavior analysis and real-time vehicle diagnosis for indication of the condition of vehicle 31.

In another implementation, vehicle 31 includes a plurality of sensors 39 located at various parts or systems of vehicle 31, and detect events or changes in its environment or the behavior or attributes of some phenomenon associated with various parts or systems of vehicle 31 or operation of vehicle 31. The sensors 39 include a signal processor and transceiver for transmitting the sensed signals and/or measurements to vehicle data acquisition system (DAS) 36, or directly to server computer 32 via a wired or wireless connection. This data is requested and received without any user intervention, and is then transmitted to server computer 32, where it is parsed and analyzed for implementation in driver behavior analysis and real-time vehicle diagnosis for indication of the condition of vehicle 31. The sensors 39 may include any of, thermal (thermometers, thermocouples), electromagnetic (ohmmeters, ammeters), mechanical (pressure gauges, flow meters, acceleration sensors, force gauges), chemical (oxygen sensors), RF ranging (RADAR), non-ionizing radiation (photodetectors), acoustic (microphones), load sensor, moisture sensor, water sensor, GPS sensor, speedometer, tachometer, distance sensor. Among other events and data that may be recorded include air bag deployment, excessive vibration, speed, harsh braking, acceleration or turning, RPMs, fuel consumption, battery levels, abs and anti slip activation, odometer reading versus time and date, car alarm activation. The recorded events and data are analysed to determine drive behaviour and/or the driving habits of the vehicle operator.

Coupled to server computer 32 are third party pricing database 40, vehicle manufacturer database 42, buyer and seller database 44, certified inspection records database 46, third party inspection reports database 48, and DIAS database 50.

Third party pricing database 40 comprises records relating to industry pricing guidelines e.g. Kelly Blue Book or Canadian Black Book pricing for a plurality of vehicles 31, each of which is associated with the vehicle's unique identifier 60.

Vehicle manufacturer database 42 comprises details of each vehicle 31, such as: make, model & year; engine details; VIN, transmission details; odometer reading/mileage, body type, drivetrain, exterior colour, interior colour, and fuel type, among others.

User database 44 comprises information pertaining to buyers and sellers of the vehicles 31. The users may include individuals and dealers, and therefore user database 44 may include details about the individuals such as first name, last name, date of birth, age, SIN/SSN, postal address, email address, telephone number, company name, and login credentials.

Certified inspection records database 46 comprises details pertaining to records generated by a certified inspector, and may include a description of vehicle 31, VIN, mileage, images of vehicle 31 documenting any wear and tear, images of inspected locations, images of any damage, images of parts. Video images of vehicle 31 and inspected parts may also be included in the report, including any accompanying audio. Certified inspection records database 46 also comprises user information, registration number, VIN, assigned inspector, inspection location, time of inspection, status, action taken and any recommended actions.

Third party inspection reports database 48 comprises inspection reports from third parties, such as CARFAX™ or CARPROOF™.

DAS database 50 comprises information collected from the plurality of electronic control units (ECUs) 38 and/or sensors 39 via data acquisition controller 36.

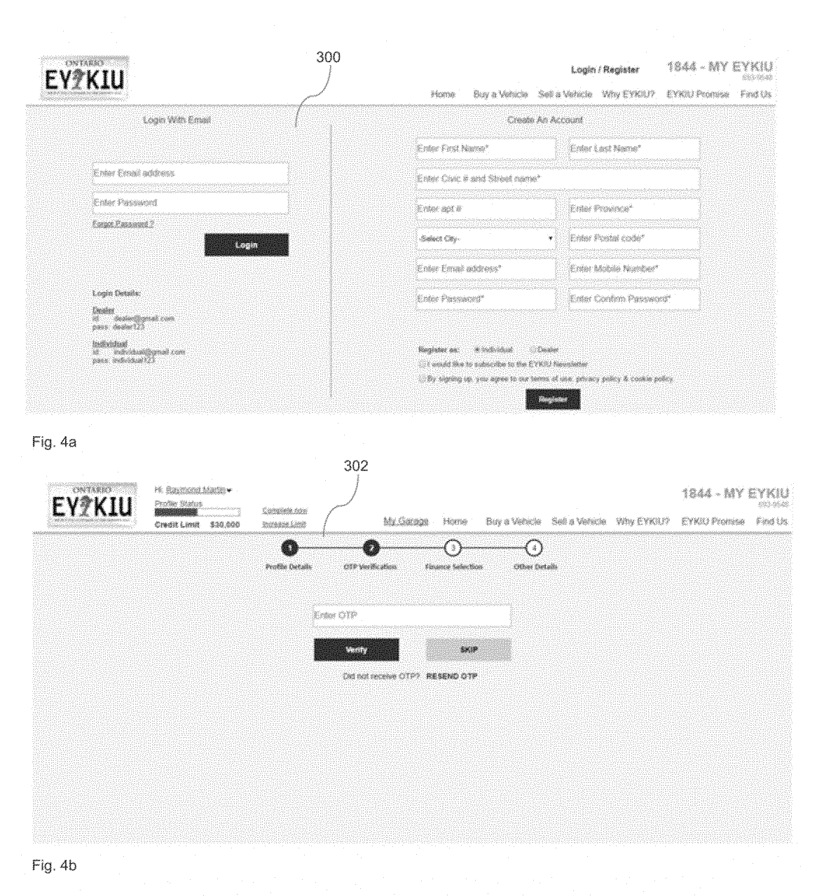

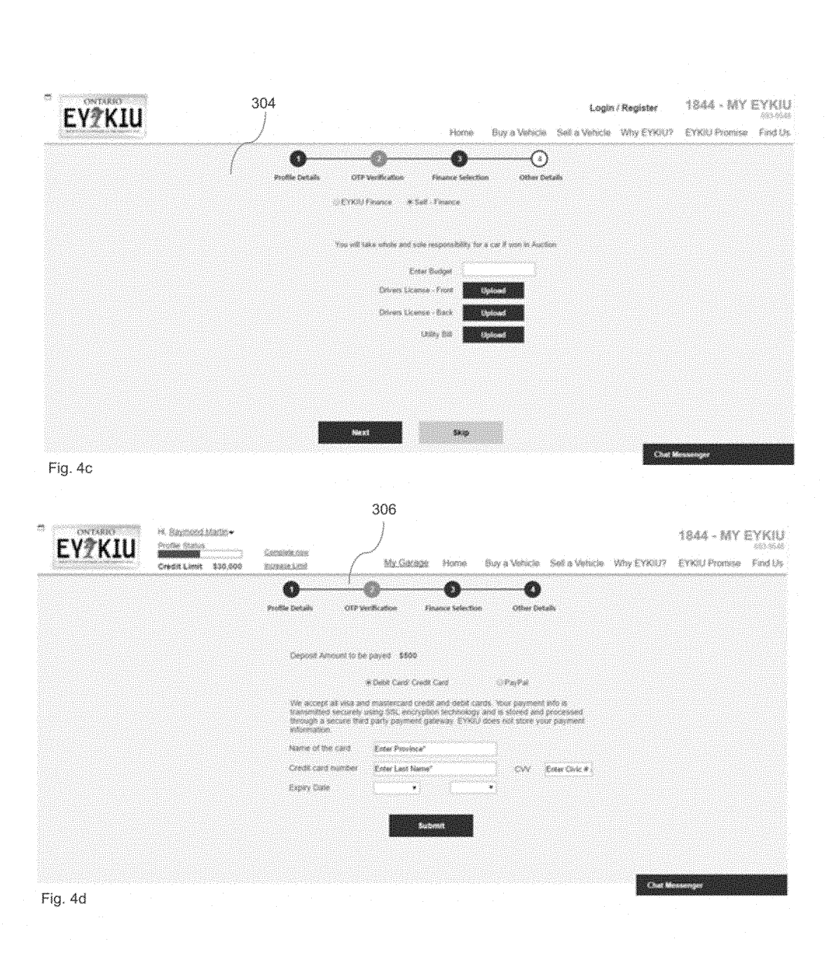

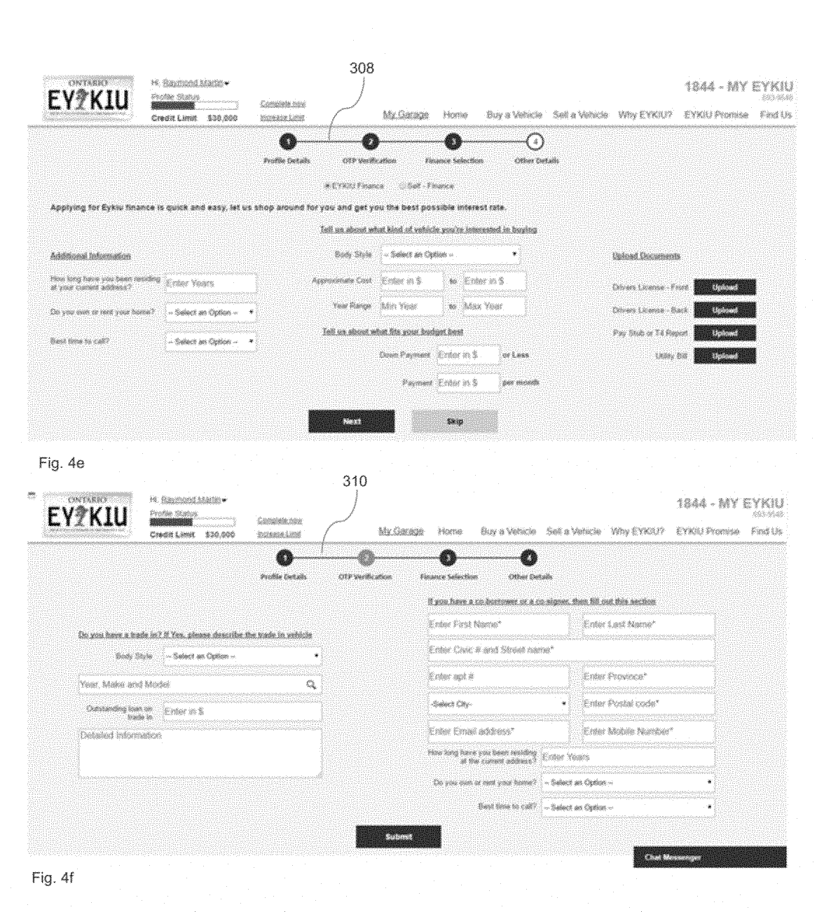

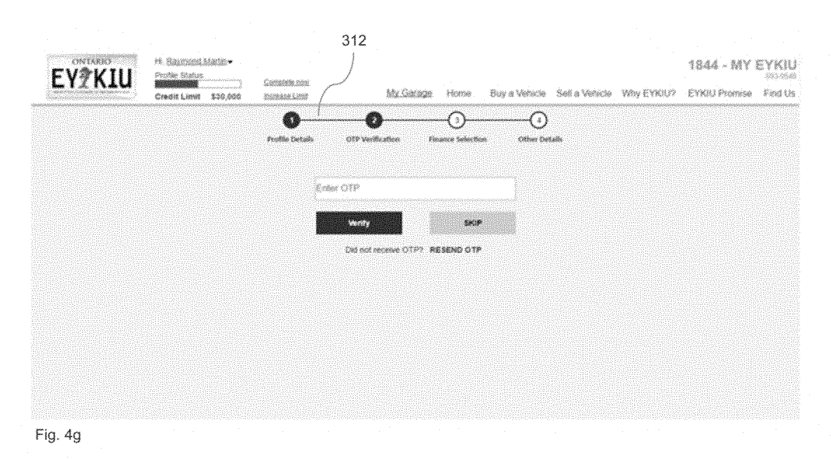

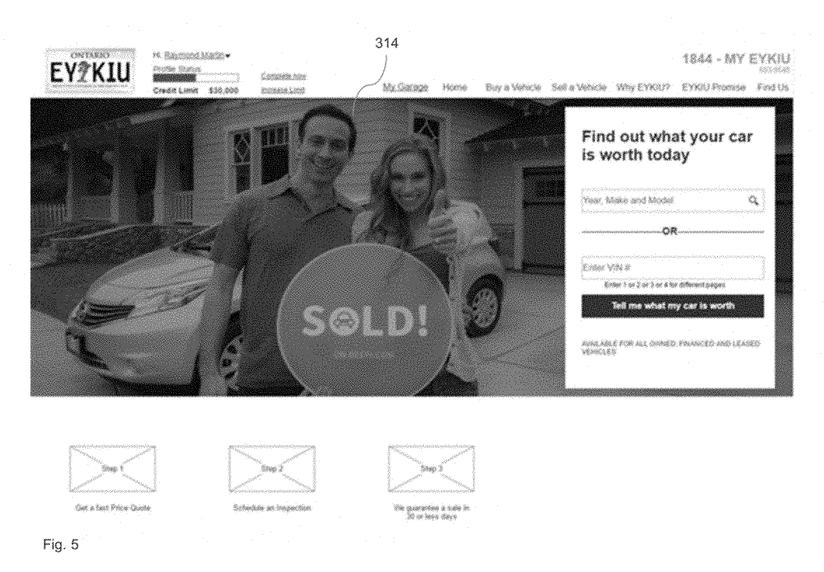

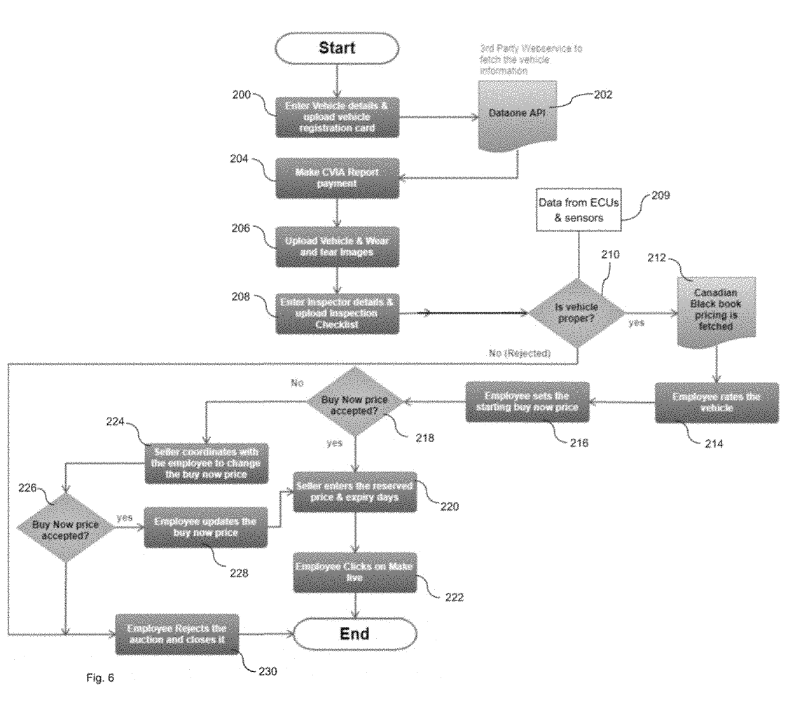

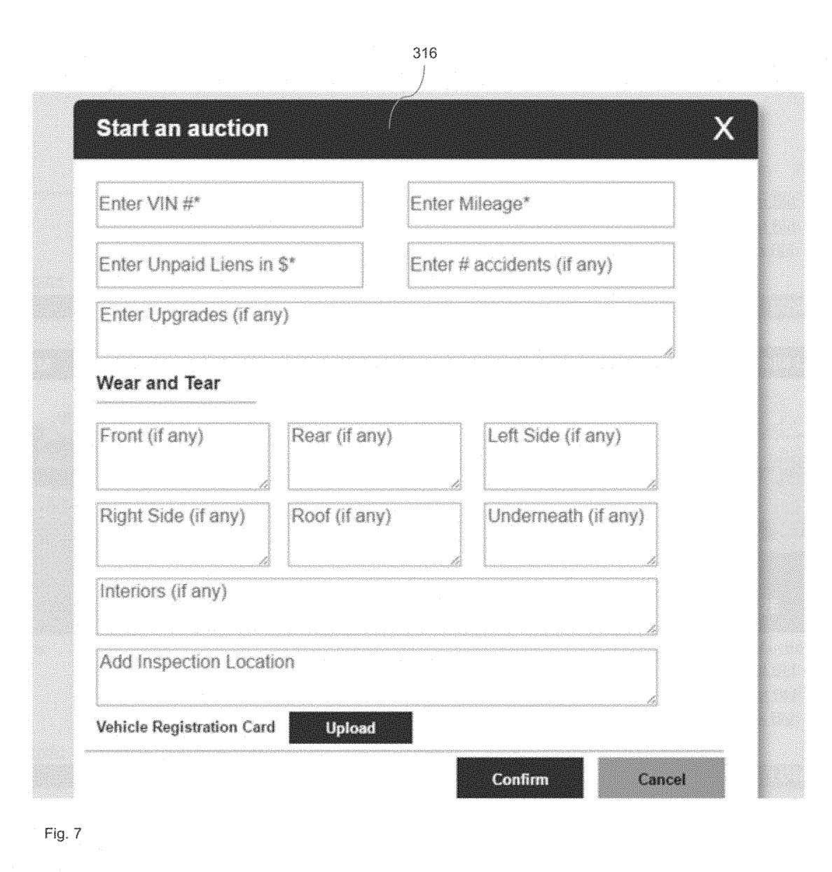

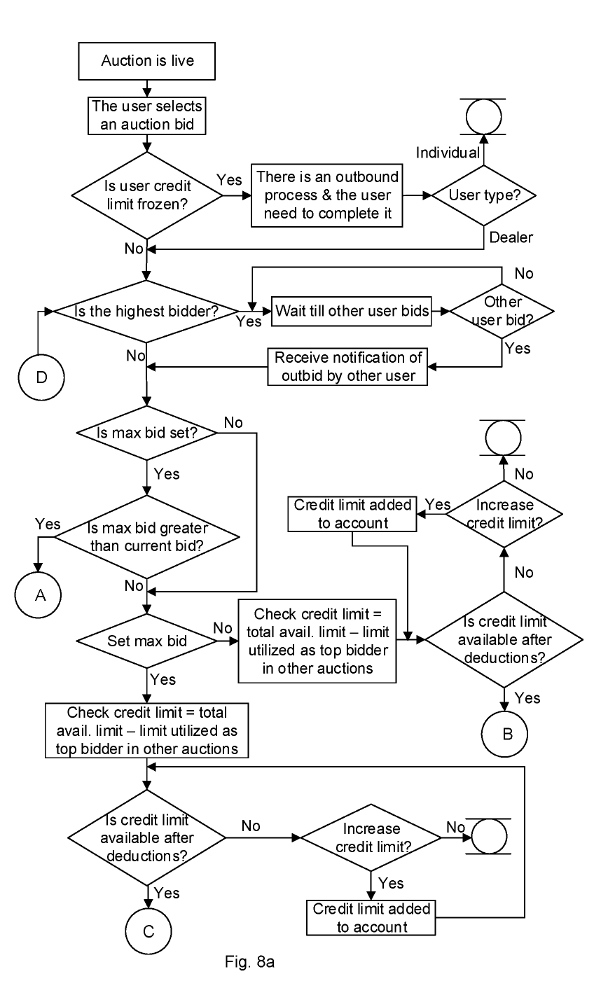

Referring to FIG. 3, an exemplary flowchart of an overview of a method for registering a user with server computer 32 which provides a vehicle auction platform. In step 100, on user computer 34, user creates a profile by entering details such as first name, last name, date of birth, age, SIN/SSN, postal address, email address, telephone number, company name, and login credentials. FIG. 4a shows an exemplary user interface 300 for registration. The entered information is transmitted to server computer 32 via communication medium 35, and stored in user database 44. Next, a verification email message is sent by server computer 32 to user mobile device 33 or user computer 34 in order to verify that the user is the owner of the email address used in the registration process. Server computer 32 then determines whether the email address has been verified, step 104, and if the email address has not been verified then the verification message is resent; however, if the email address is verified then a verification code is sent by server computer 32 to the user's mobile device 33 as part of a two-factor authentication method in order to verify that the user is the owner of the email address used in the registration process, step 106. In step 108, a determination is made as to whether a SMS message bearing a verification code has been received at the user's mobile device 33, and if the SMS message has not been received then the verification code is resent, step 110. When the SMS message is received, user then enters the received verification code for transmission back to server computer 32. Next, server computer 32 then determines whether the mobile number has been verified by checking if the verification code is correct, step 112; and if the mobile number has not been verified then the server computer 32 waits to receive the verification code within a predetermined time. When the mobile number is not verified then step 112 is repeated a predetermined number of times, and when mobile number is not verified after the predetermined number of times, the mobile verification process is skipped, and the user is presented with an interface for selection of a financing option for purchasing vehicle 31 or decline financing (step 114). FIG. 4b shows an exemplary user interface 302 for mobile verification.

In step 116, the user registration type is determined. When the user is an individual then a determination of the type of financing for use in the purchase of vehicle 31 is made (step 118). If the purchase is self-financed, or the user is determined to be a dealer from step 116, then the user (individual or dealer) enters a budget for the vehicle purchase, and sends electronic copies of supporting documents, such as a driver's license or a utility bill for identity and address verification purposes, step 120. FIG. 4c shows an exemplary user interface 304 corresponding to a self-financing option. The user is then prompted to pay a deposit amount via a payment gateway, step 124, and as shown in exemplary user interface 306 in FIG. 4d. Next, server computer 32 sends a credit limit for the purchase of vehicle 31 to the user, step 126, and the process ends. Alternatively, the deposit payment step may be skipped and server computer 32 sends a credit limit to the user following step 124.

Now returning to step 118, when a financing program is selected the user enters basic user information and sends relevant supporting documents, such as, a driver's license, a utility bill, a pay stub, a government-issued income tax document or statement of remuneration paid (T4 or W2) for identity and address verification purposes to server computer 32 (step 128). FIG. 4e shows an exemplary user interface 308 for applying for financing. Next, user enters co-borrower information (step 130), if any, otherwise this step may be skipped. FIG. 4f shows an exemplary user interface 310 for entering co-borrower information. Next, any trade-in details are entered and sent to server computer 32 (step 132) otherwise the application for financing is processed via a third-party banking partner and the financing application status is determined in step 138. When the financing is approved, server computer 32 sends a credit limit to user computer 32 or mobile device 33 (step 138) and the process ends. If required, additional information may be requested from the user in order to facilitate the financing decision. This process may be conducted online or offline (steps 134, 136). If the user skipped the mobile verification process in step 112, server computer 32 once again determines whether the mobile number has been verified to complete the registration step. FIG. 4g shows an exemplary user interface 312 for the mobile verification process.

Once the profile is complete and the user is registered, then the user is able to log onto the platform and buy or bid on vehicles via a “buy now” option or via an auction.

In another embodiment, the user can choose a combination of self and the platform finance.

Once logged in, the user is restricted to bidding on vehicles or buying vehicles only as per the credit limit provided. In order to buy or bid above the credit limit, the user is required to apply for an increase of the credit limit. The newly approved credit limit increase is added to the existing credit limit in case of self-finance and a combination of self and the platform finance and in case of only the platform finance, a new credit limit will be provided irrespective of the old limit. If the user has a vehicle to trade-in then the complete amount (current credit limit and the trade-in value) is considered as the new credit limit.

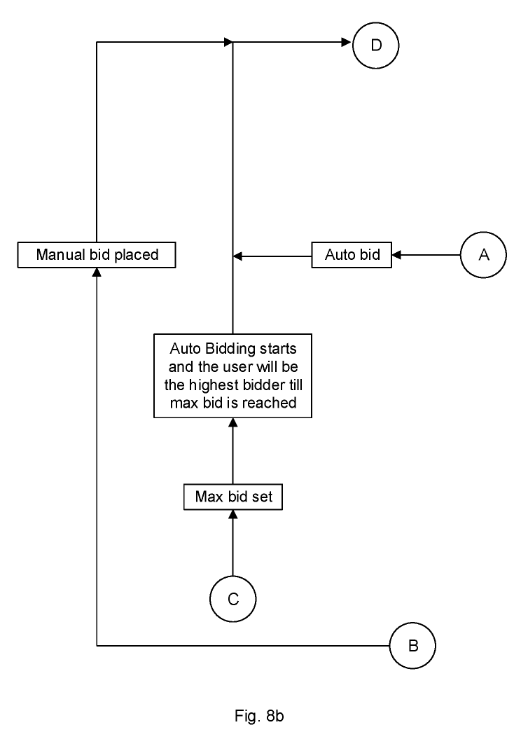

As shown in FIG. 5, the user is presented with an exemplary user interface 314 for selling vehicle 31 or starting an auction and obtaining a price estimate for vehicle 31. The user is able to receive a price estimate of vehicle 31 by entering the vehicle details, such as, year, make, model and VIN#. If the age of vehicle 31 is more than a predefined number of years e.g. 12 years, then the user is prompted to enter their name, email address & mobile number and the platform operator is notified. In the event that vehicle 31 is already registered for auction, the user is informed of the vehicle registration and is able to view the minimum & maximum wholesale price range for the trade-in vehicle, and can start an auction.

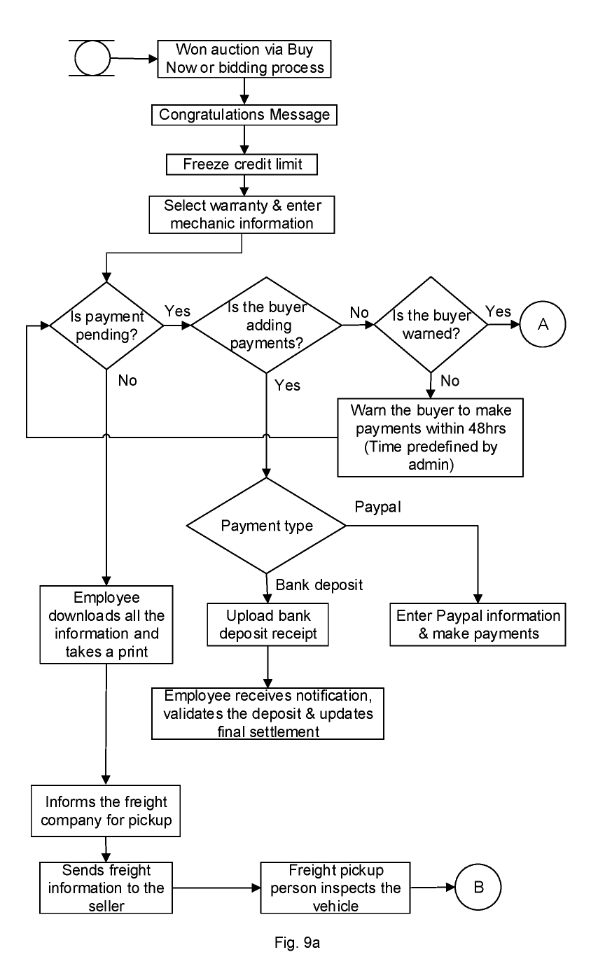

Referring to FIG. 6, an exemplary flowchart of an overview of a method for registering a vehicle on the platform and making it available for sale.

In step 200, the vehicle details and registration card are received by server computer 32 from a seller via user computer 34. Via a third-party API, vehicle history reports and vehicle reviews are requested and received by server computer 32 (step 202). Next, data acquired from ECUs 38 or sensors 39 associated with vehicle 31 is received by server computer 32 (step 209). Next, the seller is prompted to make a payment in order for the server computer 32 to generate a comprehensive master report (step 204). The user is prompted to schedule or reschedule a meeting with the platform operator to have vehicle 31 inspected. Vehicle inspector then uploads images of vehicle 31 via inspector's computing device 62, including images of vehicle 31 documenting any wear and tear (front; rear, left side, right side, roof, interior, and underneath), images of inspected locations, images of any damage, images of parts, step 206. Preferably, the inspector is equipped with an imaging device such as a handheld camera, body camera, or shoulder camera, such that the entire inspection is recorded and made available to potential buyers. The report may also be made available for interactivity via virtual reality and/or augmented reality application following processing by a virtual reality and/or augmented reality module associated with server computer 32.

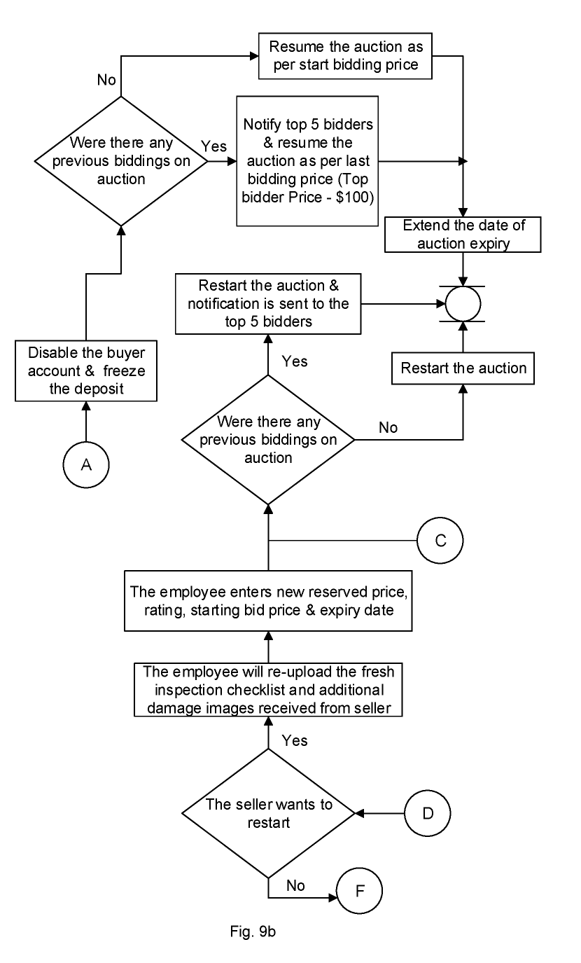

FIG. 7 shows an exemplary user interface 316 for entering details about vehicle 31, including wear and tear. Next, the inspector's details, inspection location, status and action, and the inspector's checklist are entered and sent to server computer 32, step 208. Vehicle 31 is then assigned a status e.g. certified; damaged; or low budget. If vehicle 31 is damaged, then vehicle 31 is rejected for placement on the platform and the process ends, and the user is required to pay only the inspection fees to the platform operator. If vehicle 31 is certified or low budget, then the platform operator provides the cost to make vehicle 31 as good as new, and the opening bid price will be set for the auction based on that additional cost.

In step 210, when the determination to place vehicle 31 on the platform for auction is made, then based on the year, make, model, mileage, a pricing guideline is requested by server computer 32 from an independent third-party vehicle pricing reference guide provider e.g. Kelly Book or Canadian Black Book, step 212. A comprehensive master report is generated, and includes: details and specifications pertaining to vehicle 31; independent inspection report from certified or approved inspectors; vehicle history report (e.g. CARFAX, CARPROOF, or governmental vehicle registration records such as the Department of Motor Vehicles (DMV) records or a used vehicle package); third-party vehicle pricing reference guide provider; professional reviews pertaining to vehicle 31 (e.g. Edmonds professional reviews); vehicle usage data and maintenance history information report received from the ECUs 38 or sensors 39. The data is analyzed for implementation in driver behavior analysis and real-time vehicle diagnosis for indication of the condition of vehicle 31.

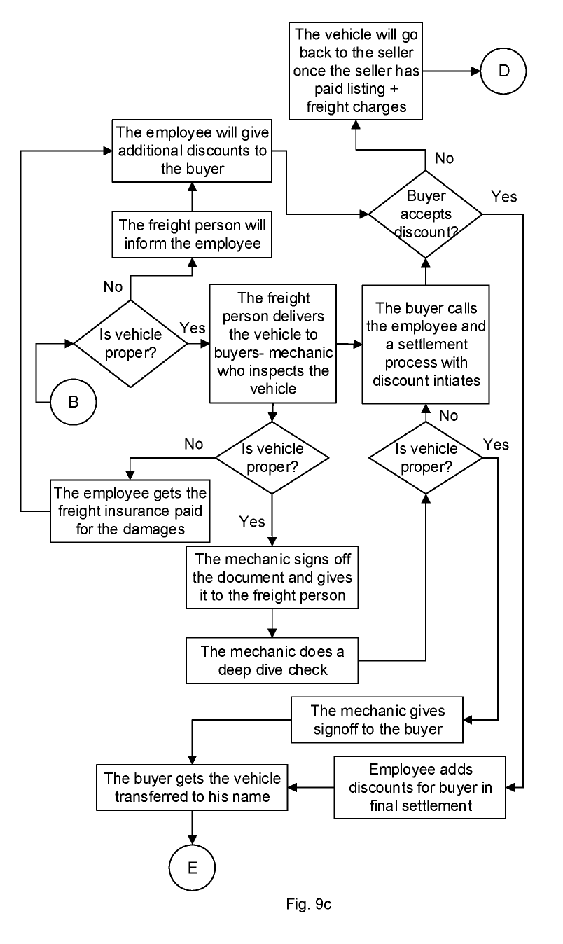

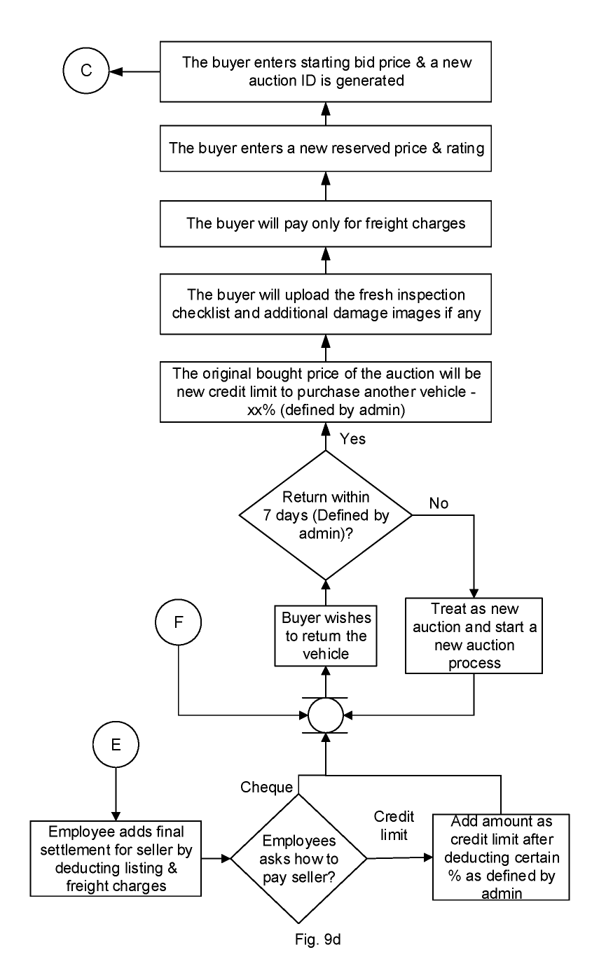

Next, vehicle 31 is rated based on the independent third-party vehicle pricing reference guide (step 214) and a “buy now” price is set (step 216). The buy now price is presented to the seller and a determination whether the “buy now” price is acceptable (step 218). If the price is acceptable then the seller enters a reserve price and sets a time threshold e.g. the number of days in which vehicle 31 must be sold (step 220). Next, the sale of vehicle 31 on the platform is made active (step 222), and the process ends. In step 218, if it is determined that the price is not acceptable, then the seller negotiates to change the buy now price (step 224) and another “buy now” price is presented to the seller and a determination whether the new “buy now” price is acceptable (step 226). If the price is acceptable then the buy now price is updated (step 228) and the seller enters a reserve price and sets a time threshold e.g. days in which vehicle 31 must be sold (step 220). Next, the sale of vehicle 31 on the platform is made active (step 222), and the process ends. In step 226, if the buy now price is not accepted, then vehicle 31 is rejected (step 230) and the process ends. Next, the bidding process starts, as shown in exemplary flowchart of FIG. 8, and when the auction ends with the sale of vehicle 31, then an outbound process is initiated as shown in exemplary flowchart of FIG. 9.

In another implementation, there is disclosed a method for minimizing depreciation of vehicles 31. Rather than investing in a losing investment by buying a vehicle, a user joins the depreciation minimization program to become a program member by putting down a deposit that is equivalent to the money they would normally invest in purchasing vehicle 31. For example, the members choose one investment category e.g. category A: $50,000; category B: $40,000; category C: $30,000; and category D: $20,000; body styles e.g. sedan, truck, motorcycle, SUV etc. and make e.g. Mercedes Benz®, Toyota®, BMW®. Vehicle 31 is purchased at wholesale price by a platform operator, and undergoes an inspection, and detailed as necessary. While the member uses vehicle 31, that very same vehicle 31 is put it up on the platform for auction for a predetermined time period e.g. 14 days. When vehicle 31 is sold, vehicle 31 is then picked up from the member, and the member receives replacement vehicle again matching is criteria and deposit. Generally, the member receives a replacement vehicle every month, with certain conditions and terms, such as, a monthly maintenance fee, allowable monthly mileage, and applicable penalties. By virtue of the monthly replacement schedule, the member is not required to change oil, tires or brakes. Insurance is the responsibility of the member as well as any damage that might occur during his usage. At any point, should the member wish to terminate the subscription, the member may provide notice to the platform operator and the member is reimbursed the deposit, and vehicle 31 is picked up. Accordingly, regardless of the time the member remains in the program, the member's initial investment never depreciates. Should the member decide to keep vehicle 31 beyond the predetermined program time period, then the member can bid on vehicle 31 on the platform, just like any other buyer. Accordingly, the member is supplied with a vehicle having an approximate value equal to the investment category; and vehicle 31 is changed periodically such that the member always has a vehicle equal to the initial investment.

In another implementation, banks, insurance companies and warranty companies will use the comprehensive master report to better assess risk; as the report includes an actual inspection on that specific vehicle as well as data generated by the ECUs 38 or sensors 39, pertaining to the condition of vehicle 31 and driving habits, and includes audio, video and images from certified inspectors.

In another implementation, third party pricing database 40, vehicle manufacturer database 42, buyer and seller database 44, certified inspection records database 46, third party inspection reports database 48, DAS database 50, may be included in a single database.

Embodiments within the scope of the present disclosure may also include non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, solid state drives, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner In certain exemplary embodiments, one or more computer systems (e.g., a standalone, user, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

1. An electronic system for determining a state of at least one pre-owned vehicle for sale, the system comprising:
an electronic unique identifier associated with said at least one vehicle;
an electronic sensing device associated with said at least one vehicle; said electronic sensing device comprising:
at least one sensing element for acquiring in real-time information
pertaining to a state of said at least one vehicle and acquiring in real-time information pertaining to the driving habits of an operator of said at least one vehicle; processing said acquired information to generate data pertaining to said at least one vehicle;
a processing unit, a memory, one or more programs stored in said memory and configured to be executed by said processing unit; coupled to said network via a transceiver, said processing unit receiving at least one vehicle history report associated with said at least one vehicle; at least one maintenance report associated with said at least one vehicle; generating a master report based on said at least one vehicle history report, said at least one maintenance report and acquired information, said master report pertaining to a state of said at least one vehicle; and determining a fair market value of at said at least one vehicle based on said master report; and a display interface coupled to said processing unit for presentation of said reports, said acquired information and said fair market value.

2. The electronic system of claim 1, wherein the at least one sensing element is at least one of an electronic control unit and an Internet of Things (IoT) device.

3. The electronic system of claim 2, wherein the at least one sensing element acquires information in real-time.

4. The electronic system of claim 3, wherein the at least one maintenance report comprises driver behavioral data, mechanical problems, error codes, component or system failures, and repairs.

5. The electronic system of claim 4, wherein the at least one vehicle history report comprises multimedia data acquired during an inspection of the at least one vehicle.

6. The electronic system of claim 5, wherein the master report comprises the at least one vehicle history report and the at least one maintenance report information.

7. The electronic system of claim 6, wherein a determination of a condition of the at least one vehicle is conducted based on the master report.

8. The electronic system of claim 7, wherein a determination of the fair market value of the at least one vehicle at the time of resale is conducted and is based on the condition of the at least one vehicle.

9. The electronic system of claim 8, wherein the master report is provided to a buyer of the at least one vehicle in a transaction anonymously without revealing the identity of a seller of the at least one vehicle.

10. The electronic system of claim 9, wherein the exchange of information pertaining to said seller and said buyer occurs once an agreement to purchase the at least one vehicle has been reached and the transaction is completed.

11. A computer-implemented method for determining a state of at least one vehicle, the method comprising the steps of:
associating said at least one vehicle with an electronic unique identifier,
associating said at least one vehicle with an electronic sensing device;
at said electronic sensing device, acquiring information pertaining to a state of said at least one vehicle and acquiring information pertaining to the driving habits of an operator of said at least one vehicle;
at a processing unit comprising a memory, one or more programs stored in said memory and configured to be executed by said processing unit, receiving said acquired information and determining said state of said at least one vehicle and acquiring said driving habits of said operator of said at least one vehicle;
at the processing unit, receiving at least one vehicle history report and at least one maintenance report associated with said at least one vehicle; and generating a master report pertaining to a state of said at least one vehicle based on said at least one vehicle history report, said at least one maintenance report, and said acquired data;
at the processing unit, receiving at least one vehicle history report and at least one maintenance report associated with said at least one vehicle; and generating a master report pertaining to a state of said at least one vehicle, said master report based on at least one of said at least one vehicle history report, said at least one maintenance report, and said acquired data; and determining a fair market value of said at least one vehicle based on said reports and said acquired data; and on a display interface coupled to said processing unit, presenting said reports, said acquired information and said fair market value.

12. The computer-implemented method of claim 11, wherein the processing unit is coupled to at least one of a vehicle database, a buyer database, a seller database, a third-party pricing database, vehicle manufacturer database, buyer and seller database, a certified inspection records database, third party inspection reports database, and a vehicle data acquisition system database.

13. The computer-implemented method of claim 12, wherein the processing unit is associated with a computer network for buying and selling the at least one vehicle.

14. The computer-implemented method of claim 13, wherein a buyer profile, a seller profile and a vehicle profile are created and stored in at least one database associated with the processing unit.

15. The computer-implemented method of claim 13, wherein the buyer profile is associated with at least one of a self-financing option and third-party financing option.

16. The computer-implemented method of claim 13, wherein when the buyer profile is associated with the self-financing option, then the buyer defines a price limit for the vehicle purchase, and wherein when the buyer profile is associated with the third-party financing option, then the processing unit defines the price limit for the vehicle purchase.

17. The computer-implemented method of claim 16, wherein the vehicle profile comprises at least one of a vehicle history report, maintenance records, vehicle reviews, sensor data and electronic control unit vehicle data, multimedia inspection data, and vehicle operator behavioral data.

18. The electronic system of claim 17, wherein the master report comprises at least one of the vehicle history report, maintenance records, vehicle reviews, sensor data and electronic control unit vehicle data, multimedia inspection data, and vehicle operator behavioral data, and the determination of a condition of the at least one vehicle is conducted based on the master report; and the determination of the fair market value of the at least one vehicle at the time of resale is conducted and is based on the condition of the at least one vehicle.

19. The computer-implemented method of claim 17, wherein the master report comprises interactivity components processed by at least one of a virtual reality and/or augmented reality module associated with the processing unit.

20. A computer-implemented method for determining a state of at least one pre-owned vehicle, the method comprising steps of:
associating the vehicle with a unique identifier;
monitoring usage of at least one component of the vehicle via networked-connected devices in real-time;
acquiring data from the networked-connected electronic sensing devices;
receiving an independent inspection report comprising images and video of the vehicle and the at least one component of the vehicle;
from a third-party database, receiving at least one of a vehicle history report, review, maintenance records, vehicle valuation and appraisal information associated with the uniquely-identified vehicle;
generating a comprehensive vehicle report comprising the acquired real-time data, the inspection report, and data from the third-party databases; and rating the condition of said vehicle and valuating said vehicle based on said comprehensive vehicle report.
